(19) United States
(12) Patent Application Publication
(10) Pub. No.: US 2010/0194264 A1
(43) Pub. Date: Aug. 5, 2010

(54) HIGH-PRESSURE DISCHARGE LAMP WITH PARTIAL COATING AND VEHICLE HEADLIGHT COMPRISING SAID LAMP

(75) Inventors: Marc Luennemann, Gerstetten (DE); Oliver Hering, Niederstotzingen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/679,683

(22) PCT Filed: Sep. 18, 2008
(86) PCT No.: PCT/EP08/62406

§ 371 Date: Mar. 24, 2010

(30) Foreign Application Priority Data
Sep. 28, 2007 (DE) 10 2007 046 559.0

(51) Int. Cl. H01J 61/40; H01J 61/42

(52) U.S. Cl. 313/489; 313/485

(57) ABSTRACT

A high-pressure discharge lamp may include at least one discharge vessel; and two electrodes, which extend into a discharge space of the discharge vessel and between which a light-emitting discharge arc is formed during operation of the high-pressure discharge lamp, wherein a partial coating is applied to a circumferential surface of the lamp in the region of an end section, on the discharge space side, of at least one of the electrodes, said partial coating changing the luminance and color temperature of the emitted light.

### TECHNICAL FIELD

The invention relates to a high-pressure discharge lamp, in particular for a vehicle headlamp, having at least one discharge vessel and two electrodes, which extend into a discharge space of the discharge vessel and between which a light-emitting discharge arc is formed during operation of the high-pressure discharge lamp. The invention furthermore relates to a vehicle headlamp provided with at least one such high-pressure discharge lamp.

### PRIOR ART

Such a high-pressure discharge lamp is described, for example, on the website www.osram.de under the product designation “XENAR®”. These conventional discharge lamps have a discharge vessel which delimits a discharge space filled with an ionizable fill, with two electrodes extending into said discharge space which are connected, for power supply thereto, to power supply lines led out of the discharge vessel and generate a gas discharge during operation of the lamp, which gas discharge forms a light-emitting discharge arc.

In order to improve the starting properties, DE 10 2004 043 636 A1, for example, has disclosed a high-pressure discharge lamp in which an electrically conductive, transparent layer in the form of an at least partial coating is applied to the surface of the discharge vessel. This coating forms, together with the electrodes and possibly with the power supply lines, a capacitor, wherein the glass of the discharge vessel lying therebetween and the fill gas in the discharge space form the dielectric of this capacitor. As a result, a dielectrically impeded discharge is produced between the electrodes and the coating in the discharge space, in particular with the aid of the radiofrequency components of the starting pulse. This dielectrically impeded discharge generates a sufficient number of free charge carriers in the discharge space in order to enable the electrical breakdown between the two electrodes of the high-pressure discharge lamp and to considerably reduce the starting voltage required therefor.

One disadvantage with such high-pressure discharge lamps is the fact that the color temperature and the luminance of the discharge arc are not uniform over the length of the discharge arc, with the result that light emitted by the lamp, in particular during use of such high-pressure lamps in motor vehicle headlamps, can result in other road users being dazzled. In particular, so-called hot spots in the discharge space of such lamps which have an extremely high color temperature can result in oncoming vehicles being dazzled.

### DESCRIPTION OF THE INVENTION

The invention is based on the object of providing a high-pressure discharge lamp and a vehicle headlamp with at least one such high-pressure discharge lamp, in which an improved light effect is enabled in comparison with conventional solutions.

This object is achieved by a high-pressure lamp having at least one discharge vessel and two electrodes, which extend into a discharge space of the discharge vessel and between which a light-emitting discharge arc is formed during operation of the high-pressure discharge lamp, wherein a partial coating is applied to a circumferential surface of the lamp in the region of an end section, on the discharge space side, of at least one of the electrodes, said partial coating changing the luminance and color temperature of the emitted light. In addition, this object is achieved by a vehicle headlamp having at least one such high-pressure lamp. Particularly advantageous embodiments of the invention are described in the dependent claims.

The coating according to the invention of the high-pressure discharge lamp in the region of an end section on the discharge space side, of at least one electrode means that the lamp appears to have greater color and luminance homogeneity and other road users, for example oncoming car drivers, are no longer dazzled or at least only to a lesser extent, since the luminance and the color temperature is changed by such a partial coating. Furthermore, such a partial coating can be used to adjust the geometry of the actual luminous element very precisely. As a result, for example, the reflector geometry of a headlamp can be matched substantially better to the discharge lamp, with the result that an improved luminance effect is achieved.

In accordance with a particularly preferred exemplary embodiment of the invention, the partial coating is in the form of a coating which reduces the luminance and color temperature of the emitted light.

In a preferred embodiment of the invention, for safety reasons at least sections of the discharge vessel of the lamp are surrounded by an outer bulb. In this case it is possible for the coating to be applied to the outer circumferential surface of the outer bulb and/or to the outer circumferential surface of the discharge vessel. A coating which has been applied to the outer circumferential surface of the outer bulb is subjected to a lower thermal load than a coating which has been applied to the discharge vessel. The application of the coating to the outer surface of the discharge vessel has the advantage over this that the coating is protected from mechanical damage and any undesirable reactions of the coating by means of a gas fill provided in the interspace between the outer bulb and the discharge vessel, in particular an inert gas fill, can be prevented. However, the invention is not restricted to such lamp types with an outer bulb, but rather the high-pressure discharge lamp can be formed with an outer bulb with the coating applied to the discharge vessel.

Preferably, in each case one coating is applied to the circumferential surface of the outer bulb and/or the discharge vessel in the region of the end sections on the discharge space side of the two electrodes.

In one embodiment of the high-pressure discharge lamp according to the invention, the coating is applied at least to one circumferential section of the outer bulb and/or the discharge vessel.

It has proven to be particularly advantageous if the coating extends in annular fashion around the outer bulb and/or the discharge vessel. In this case, the coating forms an annular covering of the very light, white hot spots with a high color temperature, with the result that the light effect of the lamp has greater color and luminance homogeneity.

In one embodiment of the high-pressure discharge lamp according to the invention, the coating is applied to the outer bulb or the discharge vessel in such a way that said coating engages around the end section of the electrode at a distance. It has proven to be particularly advantageous if in each case the coating is applied beginning approximately 0.2 to 1.2 mm, preferably 0.5 mm, in front of the end section, on the discharge space side, of the electrode, and extends in the direction of an end section of the discharge vessel. Preferably, the coating extends in each case starting from the discharge space at least as far as a fuse seal of the electrode in the discharge vessel of the high-pressure discharge lamp.

In an alternative exemplary embodiment of the invention, the coating is applied to the outer bulb or the discharge vessel beginning in each case from one end of the electrode and extends in the direction of the end sections of the discharge vessel. In this variant, at least some of the radiation emitted in the region of the ends of the electrodes is not intercepted by the coating, with the result that a very high luminance is achieved.

In order to influence the position and geometry of the coating, said coating is preferably applied using the mask or screen technique.

A coating according to the invention preferably has at least an absorption filter, an interference filter and/or a combination of such filters. Depending on the design of the coating, absorption or partial absorption of the light emitted by the discharge arc can be achieved. With an interference filter arrangement it is in particular possible to filter light in an undesired wavelength range which causes glare from the emission spectrum of the discharge lamp.

In one embodiment of the invention, the coating is applied to the outer bulb and/or the discharge vessel by means of a vacuum coating method. In the vacuum coating method, a coating with a defined layer thickness and a high adhesion strength is achieved. In this case, it is advantageous that the vacuum coating process runs continuously, i.e. no intermediate ventilation of the vacuum chamber takes place and, as a result, no contamination of the coating occurs, with the result that the quality of the coating of the high-pressure discharge lamp is substantially improved. The optical properties of the coating can be adjusted in a simple manner by virtue of the material used, the layer geometry and the thickness of the layer, in order to achieve the desired improvements in the luminance effect. In this case, the coating can include one or more materials.

In a particularly preferred exemplary embodiment of the invention, the coating is applied using the PVD sputtering technique or CVD technique. For example, a reactive PVD sputtering process is used.

In particular in the case of a high-pressure discharge lamp used in a vehicle headlamp, the uncoated section of the outer circumferential surface of the outer bulb or of the discharge vessel preferably has a sufficiently high luminance for achieving the illuminance required in accordance with the ECE standard.

### BRIEF DESCRIPTION OF THE DRAWINGS

The invention will be explained in more detail below with reference to a preferred exemplary embodiment. In the drawings:

FIG. 1 shows a schematic illustration of a high-pressure discharge lamp according to the invention, and

FIG. 2 shows a schematic illustration of the high-pressure discharge lamp shown in FIG. 1 in the region of the discharge space with the discharge arc.

### PREFERRED EMBODIMENT OF THE INVENTION

The invention will be explained below with reference to a high-pressure discharge lamp, as is used, for example, in vehicle headlamps. The high-pressure discharge lamp according to the invention is in no way restricted to such lamp types, however.

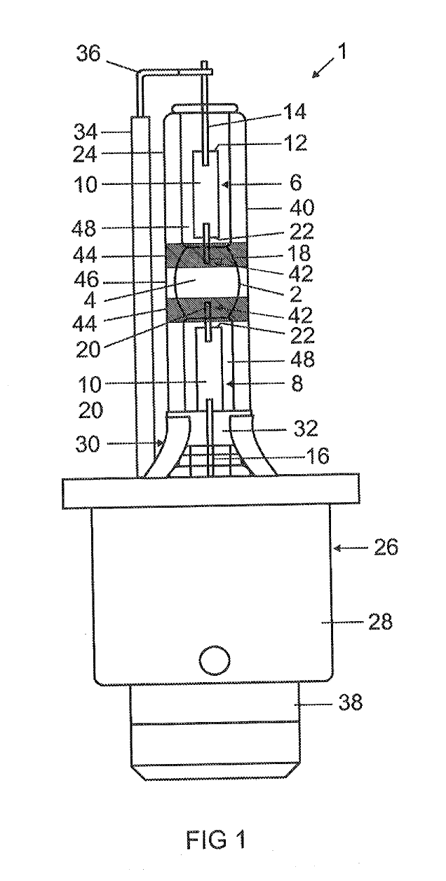

FIG. 1 shows a schematic illustration of a high-pressure discharge lamp 1 with a discharge vessel 2 (burner) consisting of quartz glass which delimits a discharge space 4 and has two diametrically arranged, sealed end sections 6, 8, in which in each case a molybdenum film 10 is embedded for passing current through in a gas-tight manner. The molybdenum films 10 are connected on a first narrow side 12 to an outer power supply line 14, 16 consisting of doped molybdenum. Two diametrically arranged electrodes 18, 20 consisting of doped tungsten, which are each connected to a second narrow side 22 of the molybdenum films 10 and between which a light-emitting gas discharge is formed during lamp operation protrude into the discharge space 4 of the discharge vessel 2. An ionizable fill which consists of high-purity xenon gas and a plurality of metal halides is enclosed in the discharge space 4 of the discharge vessel 2. The discharge vessel 2 is surrounded by an outer bulb 24, which consists of quartz glass, which is provided with dopants absorbing ultraviolet radiation. The high-pressure discharge lamp 1 also has a lamp base 26, which bears the discharge vessel 2 and the outer bulb 24. The lamp base 26 has a base housing 28 which is cylindrical in sections and consists of electrically insulating plastic for being accommodated in a lampholder (not illustrated), said base housing 28 having, on the lamp side, a fastening section 30 with a fixing ring 32 for fastening the outer bulb 24 in the base housing 28. The outer power supply line 14 of that end section 6 of the discharge vessel 2 which is remote from the base is connected to an electrical connecting ring 38 of the base 26 via a power return line 36 surrounded by an insulating sleeve 34, while the power supply line 16 which is close to the base is connected to an inner contact pin (not illustrated) of the high-pressure discharge lamp 1.

A partial coating 44 is applied to an outer circumferential surface 40 of the outer bulb 24 in the region of an end section 42, on the discharge space side of each of the electrodes 18, 20, said partial coating 44 changing, in particular reducing, the luminance and color temperature of the emitted light. The coatings 44 are applied in each case approximately in annular fashion to the outer bulb 24 in such a way that said coatings engage around the end sections 42 of the electrodes 18, 20 at a distance and extend as far as a fuse seal 48 of the electrodes 6, 8 in the discharge vessel 2. The coatings 44 according to the invention of the high-pressure discharge lamp 1 mean that the lamp appears to have greater color and luminance homogeneity and no longer dazzles, or at least to a lesser extent, other road users, for example oncoming car drivers, since the luminance and the color temperature are reduced by such a partial coating 44. Furthermore, the geometry of the actual luminous element can be adjusted very precisely by such a partial coating 44. As a result, for example, the reflector geometry of a headlamp can be matched substantially better to the discharge lamp 1, with the result that an improved luminance effect is achieved. The application of the coating 44 to the outer circumferential surface 40 of the outer bulb 24 is subjected to a lower thermal load than a coating which has been applied to the discharge vessel 2. An uncoated section 46 of the outer circumferential surface 40 of the outer bulb 24 has a sufficiently high luminance in order to achieve the illuminance required for street lighting by the ECE.

In one exemplary embodiment of the invention, which is not illustrated, the coating 44 is applied to the discharge vessel 2. The application of the coating 44 to the outer circumferential surface of the discharge vessel 2 has the advantage that the coating 44 is protected from mechanical damage and undesirable reactions of the coating by means of a gas fill, in particular an inert gas fill, provided in the interspace between the outer bulb and the discharge vessel can be prevented. Furthermore, the coating 44 can be applied to the outer bulb 24 or the discharge vessel 2 in each case beginning from one end of the electrodes 18, 20 and can extend in the direction of the end sections 6, 8 of the discharge vessel 2.

The coating 44 has at least an absorption filter, an interference filter and/or a combination of such filters and is applied to the outer bulb 24 by means of a vacuum coating method in the exemplary embodiment illustrated. In order to influence the position and geometry of the coating 44, said coating is applied, for example, using mask or screen technique. In the vacuum coating process, a coating with a defined layer thickness and high adhesion strength is achieved. In this case, it is advantageous that the vacuum coating process runs continuously, i.e. without any intermediate ventilation of the vacuum chamber taking place and, as a result, no contamination of the coating occurs, with the result that the quality of the coating of the high-pressure discharge lamp 1 is significantly improved. The optical properties of the coating 44 can be adjusted in a simple manner by virtue of the material used, the layer geometry and the thickness of the layer in order to achieve the desired improvements in the luminance effect. The coating can consist of different materials. For example, the coating can be applied using the PVD sputtering technique or CVD technique.

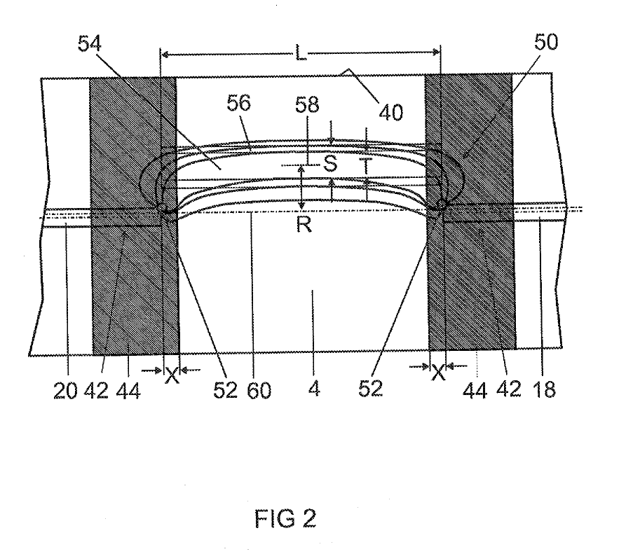

In accordance with FIG. 2, which shows a detailed view of the high-pressure discharge lamp 1 shown in FIG. 1 in the region of the discharge space 4 with the schematically illustrated discharge arc 50, the coating 44 extends in each case from a distance X of approximately 0.2 to 1.2 mm, preferably 0.5 mm, in front of the end sections 42, on the discharge space side, of the electrodes 18, 20 in the direction of the end sections 6, 8 of the discharge vessel 2 (see FIG. 1) in the exemplary embodiment illustrated. The coating 44 in this case forms an annular cover for the very light, white hot spots 52 occurring in the edge region of the electrodes 18, 20 with a high color temperature, with the result that the light effect of the lamp has greater color and luminance homogeneity. In the exemplary embodiment illustrated of the invention, the arc length L is approximately 5 mm. A central region 54 of the discharge arc 50 with the width T has at least approximately 50% of the maximum luminance. A section 56 of the discharge arc 50 with a width T is characterized by a luminance of at least approximately 20% of the maximum luminance, with a center 58 of the luminance being spaced apart from a reference axis 60 by a distance R.

The high-pressure discharge lamp 1 according to the invention is not restricted to lamps with an outer bulb 24, rather the high-pressure discharge lamp can be configured without an outer bulb 24 with the coating 44 applied to the discharge vessel 2. Furthermore, the geometry of the coating 44 is not restricted to the exemplary embodiment mentioned. In particular, the coating 44 can be applied merely to one or more circumferential sections of the outer bulb 24 or the discharge vessel 2.

The invention discloses a high-pressure discharge lamp 1, in particular for a vehicle headlamp, having at least one discharge vessel 2 and two electrodes 18, 20, which extend into a discharge space 4 of the discharge vessel 2 and between which a light-emitting discharge arc 50 is formed during operation of the high-pressure discharge lamp 1, wherein a partial coating is applied to a circumferential surface 40 of the lamp in the region of an end section 42, on the discharge space side, of at least one of the electrodes 18, 20, said partial coating 44 changing the luminance and color temperature of the emitted light. In addition, the invention discloses a vehicle headlamp with at least one such high-pressure discharge lamp.

### LIST OF REFERENCE SYMBOLS

1 High-pressure discharge lamp
2 Discharge vessel
4 Discharge space
6 End section
8 End section
10 Molybdenum film
12 Narrow side
14 Power supply line
16 Power supply line
18 Electrode
20 Electrode
22 Narrow side
24 Outer bulb
26 Lamp base
28 Base housing
30 Fastening section
32 Fixing ring
34 Insulating sleeve
36 Power return line
38 Connecting ring
40 Outer circumferential surface
42 End section
44 Coating
46 Section
48 Fuse seal
50 Discharge arc
52 Hot spot
54 Region
56 Section
58 Center
60 Reference axis

1. A high-pressure discharge lamp, comprising:
at least one discharge vessel; and
two electrodes, which extend into a discharge space of the discharge vessel and between which a light-emitting discharge arc is formed during operation of the high-pressure discharge lamp,
wherein a partial coating is applied to a circumferential surface of the lamp in the region of an end section, on the discharge space side, of at least one of the electrodes said partial coating changing the luminance and color temperature of the emitted light.

2. The high-pressure discharge lamp as claimed in claim 1, wherein the coating is configured to reduce the luminance and color temperature of the emitted light.

3. The high-pressure discharge lamp as claimed in claim 1,
wherein at least sections of the discharge vessel are surrounded by an outer bulb.

4. The high-pressure discharge lamp as claimed in claim 3, wherein the coating is applied to the circumferential surface of the outer bulb.

5. The high-pressure discharge lamp as claimed in claim 1,
wherein the coating is supplied to an outer circumferential surface of the discharge vessel.

6. The high-pressure discharge lamp as claimed in claim 1,
wherein in each case one coating is applied in the region of the end sections on the discharge space side of the two electrodes.

7. The high-pressure discharge lamp as claimed in claim 1,
wherein the at least one coating extends at least around a circumferential section of the outer bulb or the discharge vessel.

8. The high-pressure discharge lamp as claimed in claim 1,
wherein the at least one coating extends approximately in annular fashion around the outer bulb or the discharge vessel.

9. The high-pressure discharge lamp as claimed in claim 1,
wherein the at least one coating engages around the end section of the electrode at a distance.

10. The high-pressure discharge lamp as claimed in claim 1,
wherein the coating is applied beginning in front of the end section, on the discharge space side of the electrode and extends in the direction of an end section of the discharge vessel.

11. The high-pressure discharge lamp as claimed in claim 10, wherein the coating is applied beginning approximately 0.2 to 2.1 mm, in front of the end section, on the discharge space side, of the electrode, and extends in the direction of an end section of the discharge vessel.

12. The high-pressure discharge lamp as claimed in claim 1,
wherein the coating is applied to the discharge vessel beginning in each case at one end of the electrodes and extends in the direction of end sections of the discharge vessel.

13. The high-pressure discharge lamp as claimed in claim 1,
wherein the coating extends from the discharge space at least as far as a fuse seal of the electrode.

14. The high-pressure discharge lamp as claimed in claim 1,
wherein the coating has at least one of an absorption filter; an interference filter; and a combination of such filters.

15. The high-pressure discharge lamp as claimed in claim 1,
wherein the coating is applied by means of a vacuum coating method.

16. The high-pressure discharge lamp as claimed in claim 1,
wherein the coating is applied using a technique selected from the PVD sputtering technique and the CVD technique.

17. The high-pressure discharge lamp as claimed in claim 1,
wherein the coating is applied using a technique selected from the mask technique and the screen technique.

18. The high-pressure discharge lamp as claimed in claim 1, wherein an uncoated section of the circumferential surface of the outer bulb or of the discharge vessel has a luminance which enables an illuminance as required by the ECE standard.

19. A vehicle headlamp with at least one high-pressure discharge lamp, the at least one high-pressure discharge lamp comprising:
at least one discharge vessel; and
two electrodes, which extend into a discharge space of the discharge vessel and between which a light-emitting discharge are is formed during operation of the high-pressure discharge lamp,
wherein a partial coating is applied to a circumferential surface of the lamp in the region of an end section, on the discharge space side, of at least one of the electrodes said artial coating changing the luminance and color temperature of the emitted light.

20. A high-pressure discharge lamp as claimed in claim 1, wherein the high-pressure discharge lamp is configured as a vehicle headlamp.
